(19) United States
(12) Patent Application Publication
(10) Pub. No.: US 2015/0046287 A1
(43) Pub. Date: Feb. 12, 2015

(54) COMMUNICATING INFORMATION ABOUT A PRODUCT VIA AN ATTACHED TAG

(71) Applicant: Evernote Corporation, Redwood City, CA (US)

(72) Inventor: Phil Libin, San Jose, CA (US)

(21) Appl. No.: 14/336,236

(22) Filed: Jul. 21, 2014

Related U.S. Application Data
(60) Provisional application No. 61/864,324, filed on Aug. 9, 2013.

(51) Int. Cl. G06Q 30/06; H04B 5/00

(52) U.S. Cl. CPC G06Q 30/0623; G06Q 30/0633; H04B 5/0031
USPC 705/26.61

(57) ABSTRACT

Communicating information about a product includes associating a tag with the product, where the tag provides information to a smartphone of a user that interacts with the product and the tag, sending product identification information from the smartphone of the user to a back end processing system, where the information indicates an owner of the product, the back end processing system sending product sales information to the smartphone of the user in response to receiving the product identification information, the user interacting with the back end system through the smartphone to purchase the product, and the back end system recording the owner of the product and the sale to the user. The tag may be visual and may include a decorative pattern and/or a QR code. The tag may be implemented using smart fabric. The tag may be photographed using the smartphone. The tag may be an NFC tag.

### CROSS-REFERENCE TO RELATED APPLICATIONS

This application claims priority to U.S. Prov. App. No. 61/864,324, filed Aug. 9, 2013, and entitled “LARGE REFERRAL NETWORKS DRIVEN BY TAGS ATTACHED TO GOODS,” which is incorporated by reference herein.

### TECHNICAL FIELD

This application is directed to the field of processing, presenting and transmitting information, and more particularly to the field of communicating information about a product using an attached tag.

### BACKGROUND OF THE INVENTION

Networks of third party sellers and affiliates constitute a significant and growing component of today's online business. It is estimated that Amazon.com, Inc. derives around 40% of its revenue from its affiliate network (Amazon Associates), which includes almost one million members, and from nearly 1.5 million third party sellers who offer their goods and services through the Amazon marketplace. Affiliate marketing spending in the United States has nearly doubled in five years (2008-2013) from 1.8 to 3.4 billion dollars. The growth of affiliate marketing is accelerating and the overall affiliate marketing revenue is expected to reach four billion dollars in 2014. International data also shows solid growth; annual worldwide affiliate marketing commission payouts exceed seven billion dollars.

Large affiliate networks, such as Commission Junction (owned by ValueClick), are generating increasing revenues and profits; for example, annual ValueClick revenue and profit from affiliate marketing are approaching, respectively, 150 million and 90 million dollars. Among different types of online businesses that take advantage of affiliate marketing, also known as performance marketing, blog publishers are particularly successful; according to recent research, affiliate marketing scores second among revenue generating methods by bloggers.

Affiliate marketing websites employ numerous digital methods to reach prospective customers on behalf of merchants, including search engine optimization, comparison shopping, loyalty programs (rewards, points back, cash back), coupons and rebates, product reviews, blogs and website syndication, email, shopping directories, registration path affiliates, file sharing, etc. A majority of affiliate programs in countries with mature e-commerce environment are using a revenue sharing (pay per sale, abbreviated as PPS) compensation method; other methods are also used with the affiliate market, including cost per click and even cost per mille (1000 impressions), which are more broadly used in niche segments.

In order to capture a growing smartphone audience, publishers are expanding their mobile offerings on optimized websites, which leads to fast growth of mobile affiliate sales. According to UK tracking site Affiliate Window, over 20% of all June 2013 affiliate purchases in the UK have been made from mobile devices, especially from tablets; the 400 thousands mobile purchases (approximately 13 thousand sales per day) represent a 15% increase from the previous month.

In spite of significant advances, affiliate marketing campaigns may still cause controversy among online users, communities, publishers and e-commerce experts, many of whom provide criticism of affiliate marketing. Lack of standardization, guidelines and technical means to control publishers' actions may result in broad abuse of affiliate programs by spammers and other unethical online players. On the other hand, sophisticated web scripting used on publisher pages to enable affiliate programs may cause serious delays in page loading by site visitors which when combined with a related content, such as advertiser banners, may be perceived a nuisance by many web surfers and may cause damage to reputations of both affiliate publishers and advertisers. Such damage may be further complicated by published and advertiser relations with affiliate networks and by marketing methods implemented by those networks. Additionally, affiliate program fraud of different kinds, including fraudulent affiliate sales and stolen sales from other affiliates through malignant cookies and other methods, further aggravates issues facing traditional performance marketing, as well as referral programs.

Another limitation of performance marketing and of e-commerce in general manifests itself through a lack of connection of product promotions with physical goods. People in demo rooms and exhibits often need to go back to online and print catalogs to find a product they have just seen and touched. Just as with situations where a person finds a new product during a visit at a friend's, co-worker's or relative's home, these encounters don't play direct role in today's product distribution.

Accordingly, it is desirable to develop new methods and processes for distribution of goods that connects physical and virtual instances of the goods and incentivizes a broader audience to participate in referral programs beneficial for all parties.

### SUMMARY OF THE INVENTION

According to the system described herein, communicating information about a product includes associating a tag with the product, where the tag provides information to a smartphone of a user that interacts with the product and the tag, sending product identification information from the smartphone of the user to a back end processing system, where the information indicates an owner of the product, the back end processing system sending product sales information to the smartphone of the user in response to receiving the product identification information, the user interacting with the back end system through the smartphone to purchase the product, and the back end system recording the owner of the product and the sale to the user. The tag may be visual and may include a decorative pattern and/or a QR code. The tag may be implemented using smart fabric. The product may be an electronic book and the tag may be displayed on a special product page. The tag may be photographed using the smartphone. The tag may be an NFC tag. The owner may be enrolled in a referral program and the back end system may provide compensation to the owner in response to the sale. The user may be registered as a new owner in response to the sale. The tag may be decorative and visible when the product is in use or the tag may not be instantly visible on product display.

According further to the system described herein, a non-transitory computer-readable medium contains software that communicates information about a product having a tag associated therewith. The software includes executable code that provides information from the tag to a smartphone of a user that interacts with the product and the tag, executable code that sends product identification information from the smartphone of the user to a back end processing system, where the information indicates an owner of the product, executable code that sends product sales information from the back end processing system to the smartphone of the user in response to receiving the product identification information, executable code that interacts with the user through the smartphone to purchase the product, and executable code that records the owner of the product and the sale to the user. The tag may be visual and may include a decorative pattern and/or a QR code. The tag may be implemented using smart fabric. The product may be an electronic book and the tag may be displayed on a special product page. The tag may be photographed using the smartphone. The tag may be an NFC tag. The owner may be enrolled in a referral program and the back end system may provide compensation to the owner in response to the sale. The user may be registered as a new owner in response to the sale. The tag may be decorative and visible when the product is in use or the tag may not be instantly visible on product display.

The proposed system utilizes built-in physical or electronic tags, attached to individual units of sold or displayed products, uniquely identifiable by the tags, which allows registered product owners or distributors to participate in referral programs, and offers prospective customers to scan attached tags using a smartphone or another mobile device, instantly purchase new units of products, and join the same referral program as the original owner, where each new unit sold via scanning of a product tag returns to the owner of such referral unit a monetary compensation or some other compensation by seller.

The system allows each product owner or distributor to participate in a pervasive referral program simply by registering a product with a built-in referral tag. During such registration, an owner or a distributor joins the referral program and chooses a compensation method. Sales compensation may include a referral fee, a bonus program, such as point accumulation toward a new purchase or early access to new products, discounted and special product offers and other individual or combined benefits.

A pervasive referral program creates a very large distribution network by making each product owner or distributor a potential performance marketing agent for the product seller. Since such programs are completely automated, performance marketing agents don't need any special marketing or sales skills, education or training; participation of the agents in the program is driven by past purchasing history of the agents as well as the social environment and willingness of the agents to join one or multiple networks.

Pervasive referral programs with tags attached to goods may be set up by prominent e-commerce vendors, such as Amazon.com, Apple or Walmart.com through a sequence of steps explained below:
Individualized tags for each product unit are ordered from suppliers. Tags may be based on NFC chips, QR codes, recognizable smart surfaces with geometric patterns and other identification methods. Tags may be parts of a branded or decorative product design or may be hidden from instant view but still accessible (for example, the tags may be placed on a product back or bottom surface). For electronic goods such as e-books and other digital content, online services and other items, tags may be represented by QR codes displayed on a special product page and photographed by prospective customers using their mobile phones.
Tags are attached to physical goods during the production and/or packaging processes.
Owner and new customer registration and referral program logistics are implemented via e-commerce or CRM sites.
Product sales pages are offered to every individual in response to scanning and identifying an individual tag attached to a product unit. Such sales pages may open automatically on a mobile device, such as a smartphone or an augmented reality device, of a prospective customer.
Purchasers are reminded to register the product and are invited to join the referral program.
E-commerce transactions are performed and purchased products are delivered.
The system registers the sale and the owner of the product associated with the same so that owner benefits, such as referral payouts or special offers, may be generated and distributed.
Product reports and system analytics are generated and customer care and other support for the system infrastructure are provided.

Several usage scenarios for the proposed system are listed below.
1. A guest visits a friend's home and enjoys sitting in a beautiful and comfortable bergère. The guest desires to get a similar armchair for guest's own home. The friend (the bergère owner) points to a decorative element on armchair's splat and invites the guest to take a photo of the decoration with a smartphone.

The guest takes a photo of the decoration, which encodes the bergère unit and therefor the registered owner's referral account; taking the photo also directs the prospective purchaser (guest) to a dedicated product page, which is displayed on the smartphone screen and may contain product views, specifications, reviews, pricing and sales information, etc. The guest has an ability to instantly complete the purchase. Registration information and an invitation to join the affiliate program as a future product owner (and referral source) are stored on the phone of the guest—for example, as a note in an Evernote notebook. An offer to join an affiliate program may be augmented with a reminder set for activation within several days from the projected delivery date of the bergère to the guest, the new owner of a bergère. Alternatively, the guest may purchase the armchair through a simplified procedure, e.g. in a system guest mode, without even registering any new account. However, the system may generally stimulate new purchasers to register and join the referral program by offering additional discounts and other benefits.

After a new sale has been completed, the system may add another incremental sale to the a profile of the original owner, generate a respective incremental payout (a referral fee, bonus points, special offer(s) associated with incremental sales, etc.) and deliver a notification, report or payment either instantly or according to a schedule, based on system policies and possibly also based on specific requests by the owner.
2. A visitor to a partner company carries a smartphone with built-in NFC technology and watches an employee of the partner company send documents from a brand new compact scanner. The visitor asks how to get a unit for his company or home. The employee points to a logo on the scanner surface and instructs the visitor to touch the logo with the smartphone of the visitor. The smartphone reads an NFC-enabled tag combined with the logo and directs the visitor to the scanner sales page displayed on the screen of the smartphone. The rest of the purchase is similar to the previous scenario. The partner company where the scanner is located may participate in a referral affiliate program with a scanner manufacturer, distributor or other seller and may receive monetary or other benefits for incremental sales of new units referred by the company, as explained above. An example of company specific incentive may be a contract that offers the company additional volume discounts on purchases of any products from the seller based on performance by the company in the referral program.
3. A shopper visits a display room of a department store and discovers a nice dish. In order to purchase the dish, the shopper may turn the dish over and touch the bottom of the dish where an NFC tag is attached or may take a photograph of a pre-printed QR code. In response, a sales page of an online instance of the department store or of an e-commerce partner of the department store may instantly appear on the smartphone screen of the shopper and the rest of the purchase may be accomplished on the smartphone of the shopper analogously to the previous scenarios. Referral benefits for a unit sale may be assigned to the display room by a manager of a referral program. The shopper may also elect to participate in the referral program upon registration analogously to the scenario provided at item 1, above.

### BRIEF DESCRIPTION OF THE DRAWINGS

Embodiments of the system described herein will now be explained in more detail in accordance with the figures of the drawings, which are briefly described as follows.

FIG. 1 is a schematic illustration of an attached NFC tag associated with a product logo, according to embodiments of the system described herein.

FIG. 2 schematically illustrates an embedded decorative tag associated with smart fabrics, according to embodiments of the system described herein.

FIG. 3 is a schematic illustration of two different types of tags attached to a bottom product surface, according to embodiments of the system described herein.

FIG. 4 is a schematic illustration of system architecture, according to embodiments of the system described herein.

FIG. 5 is a system flow diagram illustrating processing performed in connection with a referral system, according to embodiments of the system described herein.

### DETAILED DESCRIPTION OF VARIOUS EMBODIMENTS

The system described herein provides a mechanism for creation of very large referral sales networks that may include every individual and corporate product owner and that are driven by physical tags attached to goods that may be scanned by shopper smartphones and other devices and offer products for instant purchase on shopper devices. The system provides front and back end components, software and services to enable large referral networks.

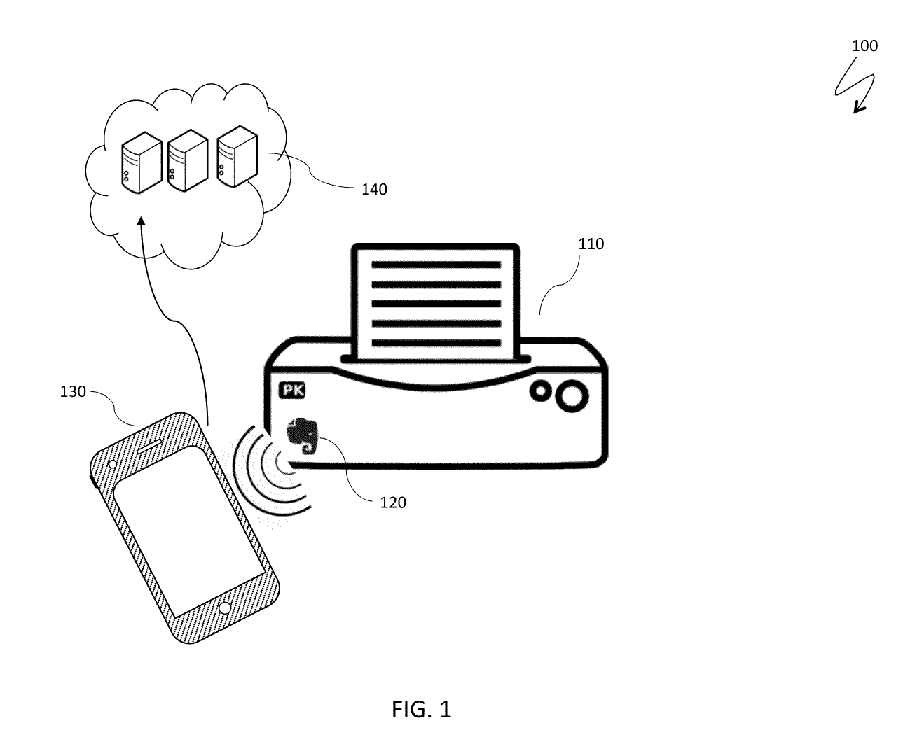

FIG. 1 is a schematic illustration 100 of an attached NFC tag associated with a product logo. A printer 110 has an NFC tag incorporated into a branded logo 120 of the printer 110, as explained elsewhere herein. A potential buyer scans the tag 120 with an NFC-enabled smartphone 130 (see scenario 2 above) and a unique identifier of the printer 110, used in connection with participating in a referral program, is transmitted by the smartphone 130 to a cloud-based back-end 140 of the referral program. Other steps of the system functioning process and system components are not presented in FIG. 1.

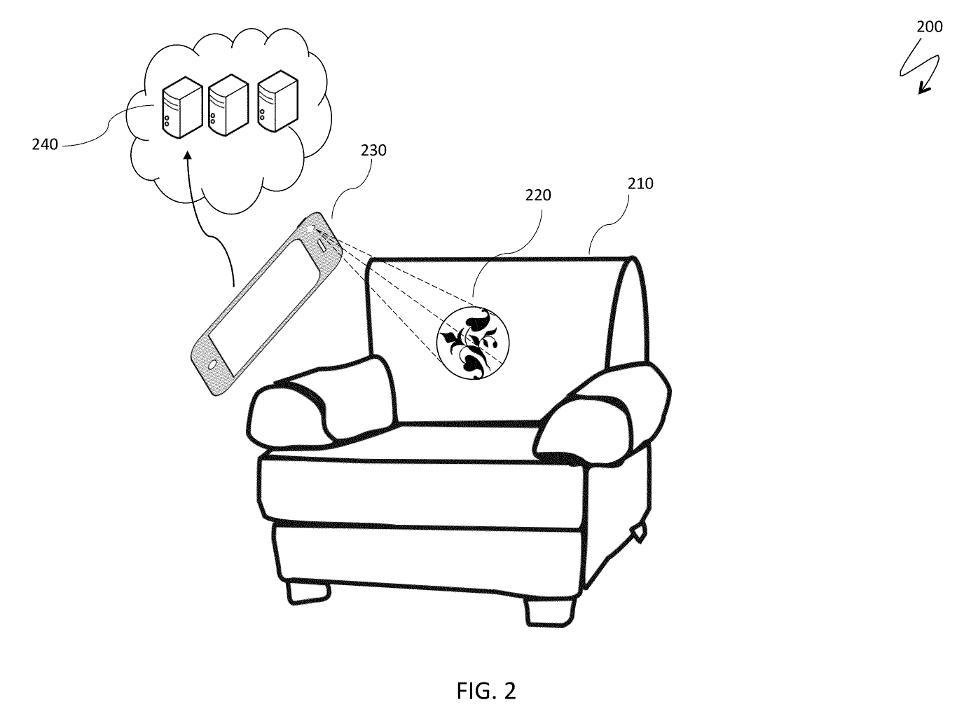

FIG. 2 is a schematic illustration 200 of an embedded decorative tag associated with smart fabrics. In the example provided in FIG. 2, product enrolled in a referral program based on unique attached tags is an armchair 210. A tag 220 having a decorative pattern that may be pre-printed is implemented as a smart fabrics identifier, such as described in U.S. patent application Ser. No. 13/958,066 titled: “USING SURFACES WITH PRINTED PATTERNS FOR IDENTIFICATION OF IMAGING AND DATA PROCESSING ACTIVITIES”, filed on Aug. 2, 2013 by Libin, et al. and incorporated by reference herein. The armchair 210 is encoded by geometric and color characteristics of the tag 220. When a user takes a photograph of the smart fabrics using a smartphone 230 having a mobile application designated for identifying smart fabrics, the system may identify the particular unit of smart fabrics in the application or on a back end processing system 240 that receives information from the smartphone 230. The system deciphers the assigned task and the back end processing system 240 handles subsequent purchasing and other functional steps of the system described herein.

Note that in the illustrations of FIGS. 1 and 2, tags attached to goods are visible and serve branding or decorative purposes as part of product design. A different role of tags is explained in the following illustration.

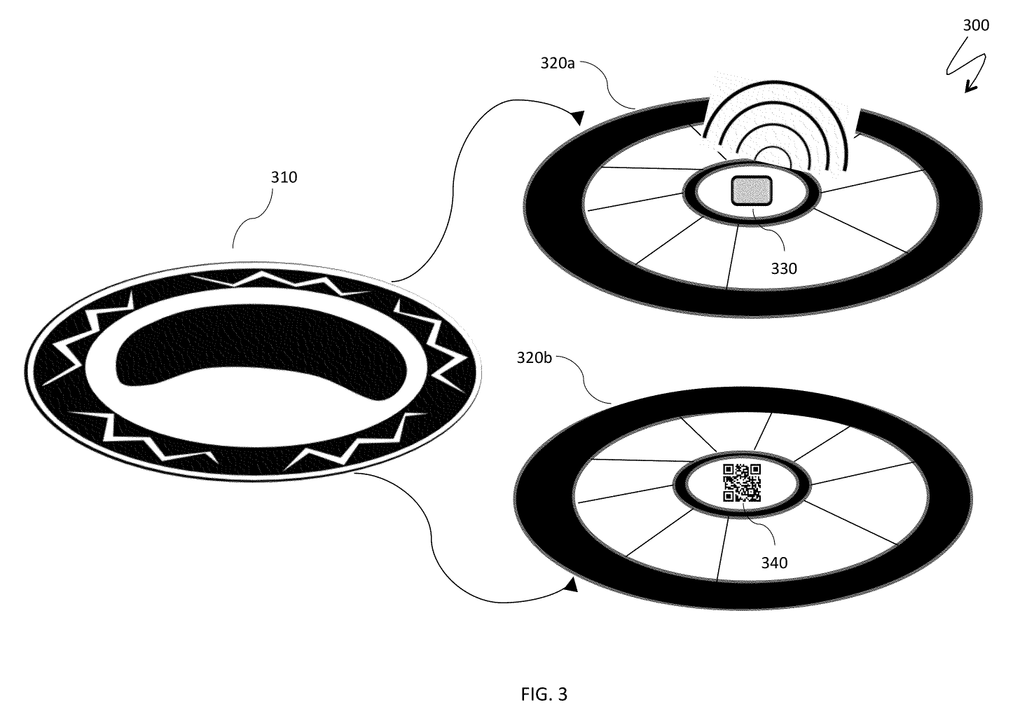

FIG. 3 is a schematic illustration 300 of two different types of tags attached to a bottom product surface and not instantly visible on a product display. A decorative dish 310 may have two different types of tags associated with a referral program and uniquely identifying every unit of the product:
An NFC tag 330 shown on a bottom surface 320a of the dish 310. The NFC tag 330 tag may be read with an NFC-enabled smartphone or other device.
A QR code 340 shown on an alternative bottom surface 320b of the dish 310. The QR code may be read with the smartphones with cameras and currently may have a broader audience reach compared with an NFC tag.

Irrespective of a particular type of tag, identifying a unit causes a shopper smartphone or other connected device to reach a cloud-based back-end of the referral program which then returns product and sales pages to the device.

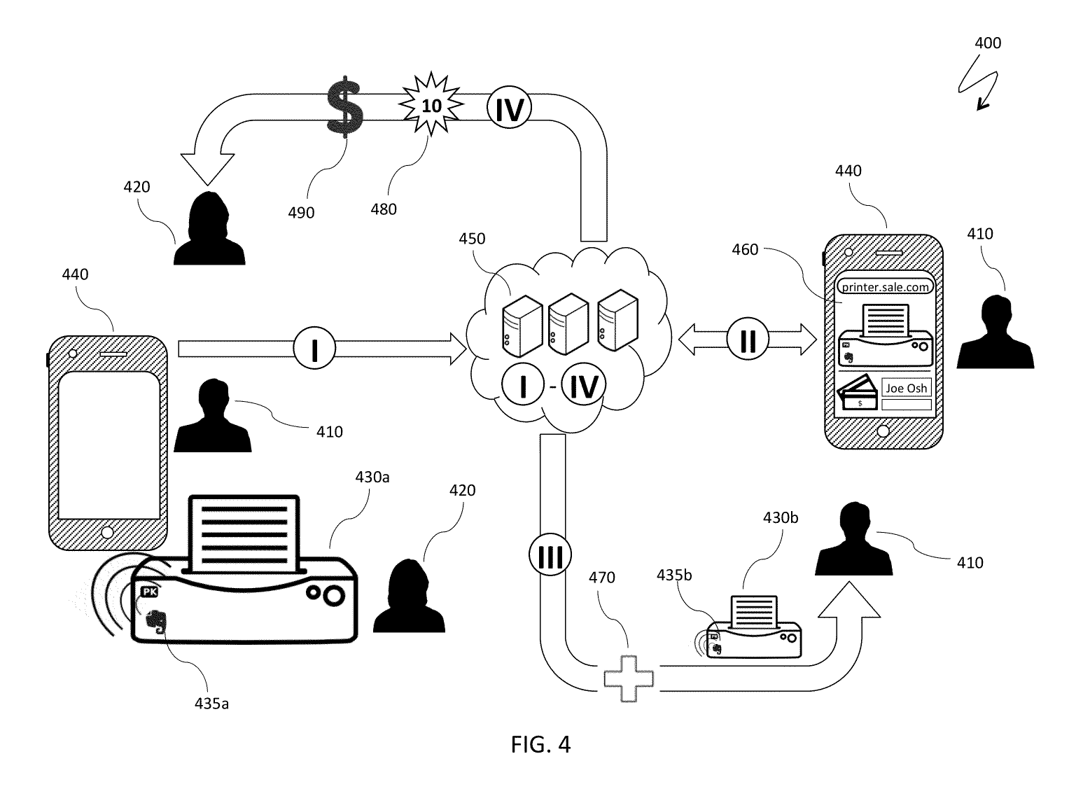

FIG. 4 is a schematic illustration 400 of architecture of the system described herein. A prospective customer 410 visits a product owner 420 and likes a product 430a (in this example, a printer). The owner 420 and the product unit 430 are enrolled into a referral program and a branded logo 435a attached to the product 430a is combined with an NFC tag transmitting a unique ID of the product 430a within the referral program, which allows the system to access an account of the owner and specific policies associated with the account. For example, if the owner is known as an active and successful referral agent, prospective customers using a reference associated with the owner may be entitled to special beneficial terms, such as discounts, add-ons or bundles.

At phase I, the prospective customer 410 scans the tag 435a with his NFC-capable smartphone 440 and a corresponding ID is transferred to a cloud-based back-end of the referral system 450, which participates in all phases I-IV illustrated in FIG. 1. Subsequently, the system retrieves a record of the product owner and of the product 430a with corresponding policies and data. The system generates product and sales pages 460 and, at phase II, sends the product and sales pages back for displaying to the prospective customer 410 on the screen of the smartphone 440. The prospective customer 410 may decide to make an instant purchase, which is shown by phase III where the prospective customer 410 may add a registration 470 with the system and purchase a printer 430b that is delivered to the customer 410. There may be different registration scenarios, starting with a guest mode where there is no registration at all (as mentioned elsewhere herein) and ending with a referral agent scenario where the customer 410 both registers for the product purchase to be identified in the future as a customer and enrolls into the referral program. In any event, a unique ID is generated for the product 430b and a tag 435b attached to the product 430b is activated, as shown by a wireless communication icon next to the tag 435b. If the customer 410 has registered for the referral program, a new account is created, a product ID is associated with the new account and the customer 410 may now distribute the product in the same way as the original owner 420.

Now that a referral sale has been completed at the phase III, the system registers the sale and the fact that the original owner 420 of the product 430a was associated with the sale and rewards the owner (referral agent) 420. This is shown in phase IV, where the system may generate a summary and a report of benefits, illustrated by an owner score 480, and may deliver an instant monetary payback 490 in a previously agreed upon form to the owner 420.

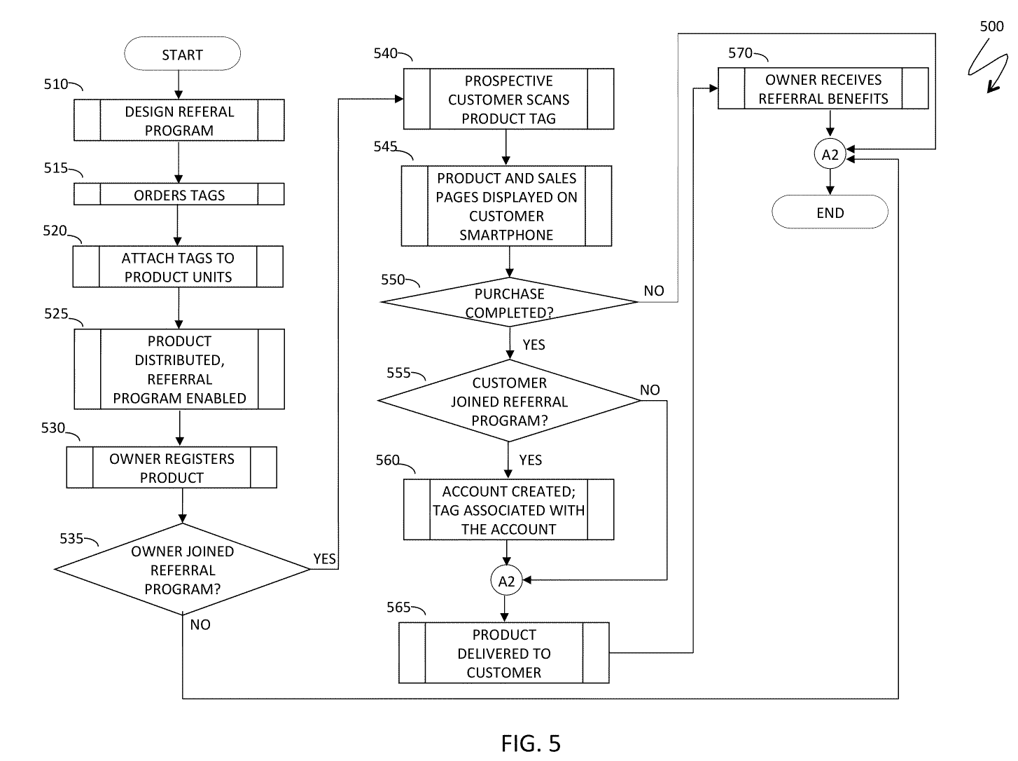

Referring to FIG. 5, a flow diagram 500 illustrates processing performed in connection with system activities. Processing starts at a step 510 where a referral program is designed. After the step 510, processing proceeds to a step 515, where appropriate tags are ordered, as explained elsewhere herein and illustrated, for example, in FIGS. 1-3. After the step 515, processing proceeds to a step 520, where the tags are activated, if necessary, to generate unique IDs that are recorded in accounts of referral agents within a referral program databases. The tags are attached to product units. After the step 520, processing proceeds to a step 525, where the product units with activated tags are distributed to an initial group of owners and the referral program is activated. After the step 525, processing proceeds to a step 530, where owners register their products. As mentioned elsewhere herein, owners may follow different registrations scenarios: the owners may completely ignore registration, register as product customers or may also join the referral program as product owner agents of the referral program. Correspondingly, after the step 530, processing proceeds to a test step 535, where it is determined whether an owner has joined the referral program. If not, processing is complete; otherwise, processing proceeds to a step 540, where a prospective customer scans a product tag, as explained elsewhere herein, including in phase I in FIG. 4.

After the step 540, processing proceeds to a step 545, where the system generates product and sales pages, delivers and displays the product and sales pages on a smartphone, smart glasses or other device of a prospective customer, as explained, for example, in connection with phase II in FIG. 4. After the step 545, processing proceeds to a test step 550, where it is determined whether the prospective customer has completed the purchase of the product within the referral program. If not, processing is complete; otherwise, processing proceeds to a test step 555 where it is determined whether the customer has registered as a referral agent and joined the referral program. If so, then processing proceeds to a step 560 where a referral account is created for the new agent (product owner); the previously generated product ID, assigned to the tag, may be associated with the referral account. After the step 560, processing proceeds to a step 565, where the product with an attached tag is delivered to the customer. Note that the step 565 may also be reached directly from the test step 555 if the customer has not joined the referral program. After the step 565, processing proceeds to a step 570 where the system generates and delivers to the original owner (referral agent) referral benefits and reports, updated by a recent sale to the new customer. After the step 570, processing is complete.

Various embodiments discussed herein may be combined with each other in appropriate combinations in connection with the system described herein. Additionally, in some instances, the order of steps in the flowcharts, flow diagrams and/or described flow processing may be modified, where appropriate. Subsequently, elements and areas of screen described in screen layouts may vary from the illustrations presented herein. Further, various aspects of the system described herein may be implemented using software, hardware, a combination of software and hardware and/or other computer-implemented modules or devices having the described features and performing the described functions. The system described herein may be implemented with any type of electronic screen capable of being actuated by a touch screen, electromagnetic or other pen.

Note that the smartphone may include software that is pre-loaded with the device, installed from an app store, installed from a desktop (after possibly being pre-loaded thereon), installed from media such as a CD, DVD, etc., and/or downloaded from a Web site. The smartphone may use an operating system such as iOS, Android OS, Windows Phone OS, Blackberry OS and mobile versions of Linux OS.

Software implementations of the system described herein may include executable code that is stored in a computer readable medium and executed by one or more processors. The computer readable medium may be non-transitory and include a computer hard drive, ROM, RAM, flash memory, portable computer storage media such as a CD-ROM, a DVD-ROM, a flash drive, an SD card and/or other drive with, for example, a universal serial bus (USB) interface, and/or any other appropriate tangible or non-transitory computer readable medium or computer memory on which executable code may be stored and executed by a processor. The system described herein may be used in connection with any appropriate operating system.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A method of communicating information about a product, comprising:
associating a tag with the product, wherein the tag provides information to a smartphone of a user that interacts with the product and the tag;
sending product identification information from the smartphone of the user to a back end processing system, wherein the information indicates an owner of the product;
the back end processing system sending product sales information to the smartphone of the user in response to receiving the product identification information;
the user interacting with the back end system through the smartphone to purchase the product; and
the back end system recording the owner of the product and the sale to the user.

2. A method, according to claim 1, wherein the tag is visual and includes at least one of: a decorative pattern and a QR code.

3. A method, according to claim 2, wherein the tag is implemented using smart fabric.

4. A method, according to claim 2, wherein the product is an electronic book and the tag is displayed on a special product page.

5. A method, according to claim 2, wherein the tag is photographed using the smartphone.

6. A method, according to claim 1, wherein the tag is an NFC tag.

7. A method, according to claim 1, wherein the owner is enrolled in a referral program and wherein the back end system provides compensation to the owner in response to the sale.

8. A method, according to claim 1, wherein the user is registered as a new owner in response to the sale.

9. A method, according to claim 1, wherein the tag is decorative and visible when the product is in use.

10. A method, according to claim 1, wherein the tag is not instantly visible on product display.

11. A non-transitory computer-readable medium containing software that communicates information about a product having a tag associated therewith, the software comprising:
executable code that provides information from the tag to a smartphone of a user that interacts with the product and the tag;
executable code that sends product identification information from the smartphone of the user to a back end processing system, wherein the information indicates an owner of the product;
executable code that sends product sales information from the back end processing system to the smartphone of the user in response to receiving the product identification information;
executable code that interacts with the user through the smartphone to purchase the product; and
executable code that records the owner of the product and the sale to the user.

12. A non-transitory computer-readable medium, according to claim 11, wherein the tag is visual and includes at least one of: a decorative pattern and a QR code.

13. A non-transitory computer-readable medium, according to claim 12, wherein the tag is implemented using smart fabric.

14. A non-transitory computer-readable medium, according to claim 12, wherein the product is an electronic book and the tag is displayed on a special product page.

15. A non-transitory computer-readable medium, according to claim 2, wherein the tag is photographed using the smartphone.

16. A non-transitory computer-readable medium, according to claim 11, wherein the tag is an NFC tag.

17. A non-transitory computer-readable medium, according to claim 1, wherein the owner is enrolled in a referral program and wherein the back end system provides compensation to the owner in response to the sale.

18. A non-transitory computer-readable medium, according to claim 11, wherein the user is registered as a new owner in response to the sale.

19. A non-transitory computer-readable medium, according to claim 11, wherein the tag is decorative and visible when the product is in use.

20. A non-transitory computer-readable medium, according to claim 11, wherein the tag is not instantly visible on product display.
